(19) United States
(12) Patent Application Publication
(10) Pub. No.: US 2025/0234447 A1
(43) Pub. Date: Jul. 17, 2025

(54) SHIELD-INTEGRATED ROTATIONAL DISK EUV LIGHT SOURCE DEVICE INCLUDING FRAGMENT SHIELD

(71) Applicant: ESOL, Inc., Hwaseong-si (KR)

(72) Inventor: Dong Gun LEE, Hwaseong-si (KR)

(73) Assignee: ESOL, Inc., Hwaseong-si (KR)

(21) Appl. No.: 18/954,401

(22) Filed: Nov. 20, 2024

(30) Foreign Application Priority Data
Jan. 11, 2024 (KR) 10-2024-0004849
Aug. 5, 2024 (KR) 10-2024-0104159

(51) Int. Cl. H05G 2/00

(52) U.S. Cl. CPC H05G 2/0082; H05G 2/0025

(57) ABSTRACT

The present invention relates to a shield-integrated rotational disk EUV light source device including a fragment shield, including: a rotational disk having a rotational disk rim which melts a target material for generating EUV light through plasma reactions; a plurality of rotational disk ribs supporting the rotational disk rim so that EUV light penetrates relative to a predetermined area among a light focusing region; and a fragment shield surrounding a plasma reaction region of the rotational disk rim to prevent the generation of target material fragments when the target material melted on the rotational disk rim causes a plasma reaction by the beam emitted from the laser source.

### CROSS REFERENCE TO RELATED APPLICATION OF THE DISCLOSURE

The present application claims the benefit of Korean Patent Application Nos. 10-2024-0004849 filed on Jan. 11, 2024, and 10-2024-0104159 filed on Aug. 5, 2024, the entire contents of which are incorporated herein by reference.

### BACKGROUND OF THE INVENTION

### Field of the Invention

The present invention relates to a shield-integrated rotational disk EUV light source device including a fragment shield, and more specifically, to a shield-integrated rotational disk EUV light source device including a fragment shield, which can significantly enhance light collection efficiency and prevent target materials from being scattered, thereby generating stable EUV light.

### Background Art

Methods for producing EUV light include a process of converting a material into a plasma state which has at least one element, such as xenon, lithium or tin, with at least one emission line within the EUV range. In one of the methods, required plasma, often referred to as laser-produced plasma (LPP), can be produced by irradiating a target material containing line-emitting elements required as a laser beam.

One specific LPP technique involves irradiating target material droplets to one or more pre-pulses and main pulses.

In this context, a CO₂ laser can provide specific advantages when a driving laser produces the “main pulse” in an LPP process. This may be especially true for certain target materials, such as tin droplets, For example, one advantage may include the ability to produce a relatively high conversion efficiency, for instance, a ratio between the drive laser input power and the output EUV in-band power.

Light source devices generating EUV light are generally categorized into an off-axis structure and an on-axis structure, and include a rotator-type target material feeder, which stably induces an reflection angle of an optical system and a plasma reaction. The rotor-type light source devices supplying target materials have been widely adopted in conventional technologies due to their ability to stably induce plasma reactions. The rotor-type light source devices are typically designed with off-axis type light output structures depending on light output structures.

The off-axis structure is advantageous in terms of optical system arrangement, but is disadvantageous in that light collection efficiency is deteriorated.

### PATENT LITERATURE

### Patent Documents

Patent Document 1: Korean Patent No. 10-1811306
Patent Document 2: Korean Patent No. 10-0875569
Patent Document 3: Korean Patent No. 10-2207666
Patent Document 4: Korean Patent No. 10-1484937
Patent Document 5: Korean Patent Publication No. 10-2011-0110578
Patent Document 6: Korean Patent Publication No. 10-2008-0041671

### SUMMARY OF THE INVENTION

Accordingly, the present invention has been made to solve the above-mentioned problems occurring in the prior arts, and it is an objective of the present invention to provide a shield-integrated rotational disk EUV light source device including a fragment shield, which can significantly enhance light collection efficiency by improving the light focusing structure while maintaining the existing target material supply system requiring the plasma reaction for the EUV light generation.

Specifically, an objective of the present invention is to provide an objective of the present invention is to provide an optical system of an on-axis structure in an EUV light generation device of a rotational disc structure to supply target materials continuously and stably, thereby significantly enhancing light collection efficiency.

To accomplish the above objective, according to the present invention, there is provided a shield-integrated rotational disk EUV light source device including a fragment shield, including: a rotational disk having a rotational disk rim which melts a target material for generating EUV light through plasma reactions; a plurality of rotational disk ribs supporting the rotational disk rim so that EUV light penetrates relative to a predetermined area among a light focusing region; and a fragment shield surrounding a plasma reaction region of the rotational disk rim to prevent the generation of target material fragments when the target material melted on the rotational disk rim causes a plasma reaction by the beam emitted from the laser source.

Moreover, the rotational disk ribs supporting the rotational disk rim are configured to allow EUV light to penetrate relative to a predetermined area of a light focusing region through a collector mirror, which irradiates the beam emitted from a laser source to the target material by penetrating the beam to the center, receives the EUV light reflected from the target material, and collects the EUV light to the same incident light axis.

Furthermore, the fragment shield has a single beam hole through which the laser emitted from the laser source is received and the EUV light generated from the target material passes.

Additionally, the fragment shield has a circular shape to surround the inner circumferential surface of the rotational disk rim formed on the inner surface of the rotational disk.

In addition, the beam hole has a predetermined diameter size to have an angle identical to the incident angle of the laser beam emitted from the laser source, and the EUV light generated by the interaction with the target material is reflected at an angle of the beam hole to be reflected to the collector mirror.

Moreover, the fragment shield is formed to cover only a certain section with a predetermined length relative to the inner diameter of the rotational disk rim formed on the inner surface of the rotational disk.

Furthermore, the rotational disk rib includes a single rotational disk hub positioned at the center to connect the rotational disk hub to the rotational disk rim.

Additionally, the rotational disk hub includes an upper flange and a lower flange, which are connected to the rim flange via the rotational disk rim.

Moreover, the fragment shield has an “L” shape and is fixedly installed to cover the inner surface of the rotational disk rim.

Furthermore, when EUV light is generated by reaction between laser emitted from the laser source and the target material of the rotational disk rim according to the incident angle of the laser, the EUV light source device reflects the EUV light to the collector mirror at an angle identical to the incident angle, and then, reflects the EUV light from the collector mirror in an on-axis structure with the same incident angle.

In addition, when EUV light is generated by reaction between laser emitted from the laser source and the target material of the rotational disk rim according to the incident angle of the laser, the EUV light source device reflects the EUV light to the collector mirror at an angle identical to the incident angle, and then, reflects the EUV light from the collector mirror in an off-axis structure with the same incident angle.

The present invention having the above configuration can provide an on-axis type EUV light source device, which can provide excellent light collection efficiency through the arrangement of the collector mirror and the structure of the rim formed on the rotational disk to maintain the target material supply structure according to plasma reactions of the EUV light source device and realize the on-axis structure.

### BRIEF DESCRIPTION OF THE DRAWINGS

FIG. 1 is an overall configuration of a shield-integrated rotational disk EUV light source device including a fragment shield according to the present invention.

FIG. 2 is a plan view of a shield-integrated rotational disk EUV light source device including a fragment shield according to an embodiment of the present invention.

FIG. 3 is a plan view of a shield-integrated rotational disk EUV light source device including a fragment shield according to another embodiment of the present invention.

FIG. 4 is a plan view of a shield-integrated rotational disk EUV light source device including a fragment shield according to a further embodiment of the present invention.

FIG. 5 is a cross-sectional view of a rotational disk from FIG. 4.

FIG. 6 is a plan view of a shield-integrated rotational disk EUV light source device including a fragment shield according to a still further embodiment of the present invention.

FIG. 7 is a plan view of a shield of the shield-integrated rotational disk EUV light source device including a fragment shield according to the present invention.

FIG. 8 is a plan view illustrating a state in which the shield-integrated rotational disk EUV light source device including a fragment shield is arranged in an off-axis configuration according to the present invention.

FIG. 9 is a sectional view of the fragment shield of the shield-integrated rotational disk EUV light source device according to the present invention.

FIG. 10 is a sectional enlarged view of the fragment shield of the shield-integrated rotational disk EUV light source device according to the present invention.

FIG. 11 is a diagram of the fragment shield of the shield-integrated rotational disk EUV light source device according to the present invention, viewed from the inside.

FIG. 12 is a perspective view of a fragment shield of a shield-integrated rotational disk EUV light source device including a fragment shield according to another embodiment of the present invention.

FIG. 13 is a plan view of the fragment shield according to FIG. 12.

### DETAILED DESCRIPTION OF THE INVENTION

Hereinafter, a shield-integrated rotational disk EUV light source device including a fragment shield according to the present invention will be described in detail with reference to the accompanying drawings.

The shield-integrated rotational disk EUV light source device including a fragment shield according to the present invention includes: a rotational disk having a rotational disk rim which melts a target material for generating EUV light through plasma reactions; a plurality of rotational disk ribs supporting the rotational disk rim so that EUV light penetrates relative to a predetermined area among a light focusing region; and

The shield-integrated rotational disk EUV light source device including a fragment shield, according to the present invention, applies a target material supply device with a superior structure for generating an EUV light source and applies an on-axis type light focusing structure, thus significantly enhancing light collection efficiency compared to conventional EUV light source devices.

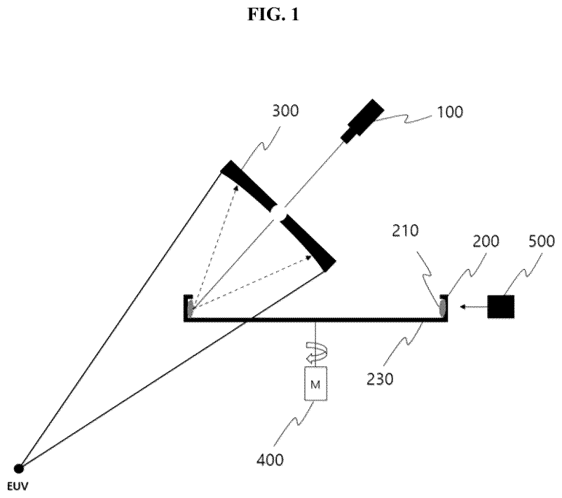

FIG. 1 is an overall configuration of a shield-integrated rotational disk EUV light source device including a fragment shield according to the present invention.

The EUV light source device according to the present invention primarily includes: a laser source 100, a rotational disk 200 which confines molten target material in a reaction space using centrifugal force for plasma reactions; a heating means 500 for melting the target material 210 located in the reaction space of the rotational disk 200; and a collector mirror 300 which irradiates the beam output from the laser source 100 to the target material by allowing the beam to pass centrally, receives the reflected EUV light, and collects the EUV light to the same incident light axis. According to the technical concept of the present invention, the rotational disk 200 includes rotational disk ribs 230 with a penetration structure relative to a predetermined area among the light focusing region where the EUV light is focused through the collector mirror 300.

In one embodiment of the present invention, the laser source 100 may be a laser source with a pulse frequency ranging from 50 kHz to 200 kHz.

Additionally, the RPM of the rotational disk 200 can be determined according to the pulse repetition rate of the laser source, and the rotational speed of the rotational disk can be determined by a laser repetition rate.

Accordingly, a portion of the EUV light collected and output by the collector mirror 300 is designed to pass through (or penetrate) the rotational disk ribs 230 of the rotational disk 200 in an on-axis type optical output structure, thus effectively solving the problem of conventional arts where light focusing amount is reduced in the conventional off-axis structures.

Here, the heating means 500 for melting the target material 210 preferably surrounds the exterior of the rotational disk and heats the target material supplied to the inner surface (rim) of the rotational disk to melt the target material. The heating means can use various heating elements, such as laser heating, induction methods, or ceramic-based heating elements.

Furthermore, the collector mirror 300 may include a separate heating device (not shown). The heating device can be used in a chamber of the EUV light source device to clean off fragmented target material particles, which may be generated by the target material and might interfere with the optical properties of the collector mirror or other optical systems and components, by heating the collector mirror, optical systems or components. Therefore, the heating device can be adopted as a cleaning means, and can be configured inside the chamber of the EUV light source device to remove fragment particles.

Therefore, the present invention can provide a fragment removal function using the heating device for removing fragments generated by the target material in the rotational disk-based EUV light source device.

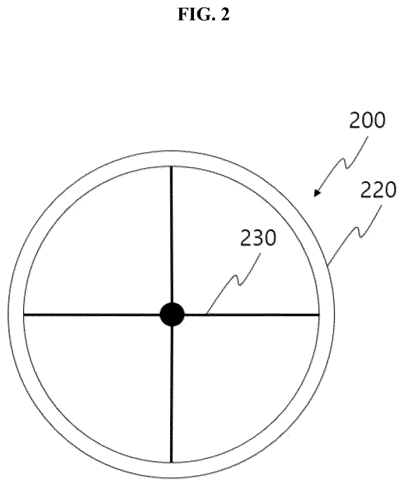

FIG. 2 is a plan view of a shield-integrated rotational disk EUV light source device including a fragment shield according to an embodiment of the present invention.

FIG. 2 illustrates the rotational disk 200 in a planar view. The rotational disk 200 has a circular structure, and rotates via a driving means. In this instance, the rotational disk 200 includes: a rotational disk rim 220 for holding the target material; and a plurality of rotational disk ribs 230 supporting the rotational disk rim 220 from a rotary shaft.

The plurality of rotational disk ribs 230 are configured to allow EUV light collected by the collector mirror 300 to penetrate when the light is collected in the on-axis manner, such that light focused by the collector mirror 300 can be penetrated.

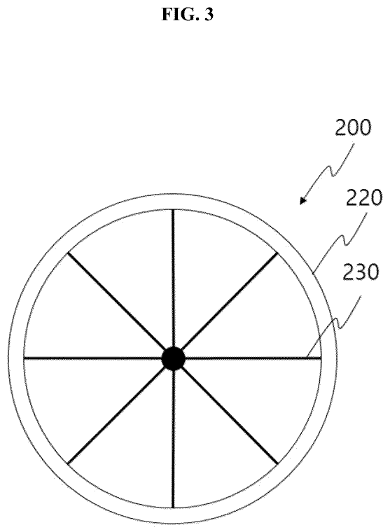

FIG. 3 is a plan view of a shield-integrated rotational disk EUV light source device including a fragment shield according to another embodiment of the present invention.

The rotational disk ribs 230, preferably, has a spoke structure to minimize interference when the focused EUV light is penetrated.

Since the rotational disk is configured to have a plurality of spokes, the rotational disk ribs of the rotational disk can effectively collect the generated EUV light when collecting the light focused on the collector mirror in the on-axis manner.

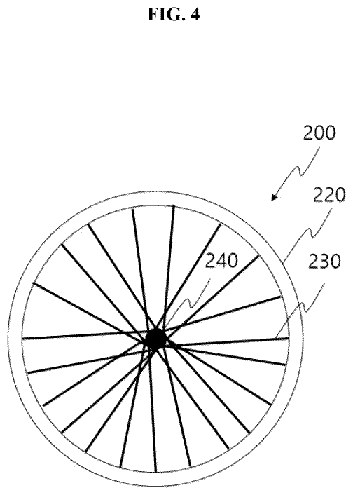

FIG. 4 is a plan view of a shield-integrated rotational disk EUV light source device including a fragment shield according to a further embodiment of the present invention.

In the present invention, to ensure the structural stability of the rotational disk 200, the rotational disk rim 220, and the rotational disk ribs 230, various coupling structures between the rotational disk rim 220 and the rotational disk ribs 230 can be proposed.

As illustrated, a rotational disk hub 240 may be configured at the rotational center shaft, and the rotational disk ribs 230 are assembled between the rotational disk hub 240 and the rotational disk rim 220 in a cross-type (tangent-type) structure. The cross-type structure is configured such that the plurality of rotational disk ribs (spokes) are intersected to support each other, thereby enhancing rigidity to safely withstand external resistance, such as torsion of the rotational disk rim 220 or lateral impacts, by rotational forces. The number of intersecting rotational disk ribs can range from one to four according to patterns.

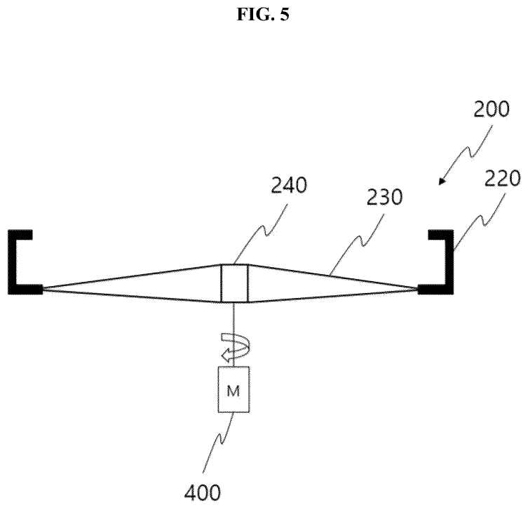

FIG. 5 is a cross-sectional view of a rotational disk from FIG. 4. The rotational disk hub 240 is provided at the rotational disk shaft, and the rotational disk ribs 230 intersect to support the rotational disk rim 220. The rotational disk hub 240 is coupled to a driving means 400 to receive rotational force, confines the target material located on the rotational disk rim 220 by centrifugal force, and reacts with the laser emitted from the laser source to generate EUV light through plasma reactions.

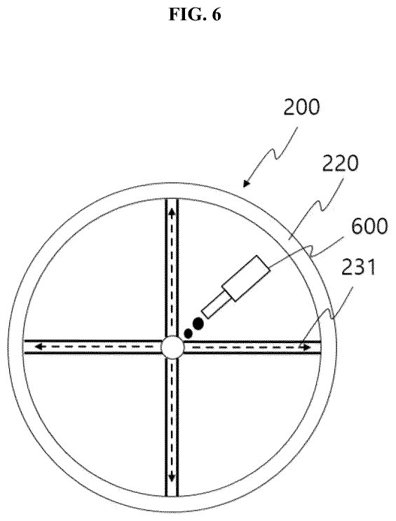

FIG. 6 is a plan view of a shield-integrated rotational disk EUV light source device including a fragment shield according to a still further embodiment of the present invention.

In the still further embodiment of the present invention, the rotational disk ribs 230 includes supply channels 231 of a predetermined width to supply the target material supplied from a target feeder located, which feeds the target material from the rotational center shaft, to the rotational disk rim. A droplet feeder 600 for supplying the target material is positioned above the center shaft.

When the plasma reactions are induced to generate EUV light, the target material positioned on the rotational disk rim decreases, and the droplet feeder 600 continuously supplies the reduced amount of target material, thus providing stable plasma reactions.

As described above, the on-axis type EUV light source device can provide excellent light collection efficiency through the arrangement of the collector mirror and the structure of the rim formed on the rotational disk to maintain the target material supply structure according to plasma reactions of the EUV light source device and realize the on-axis structure.

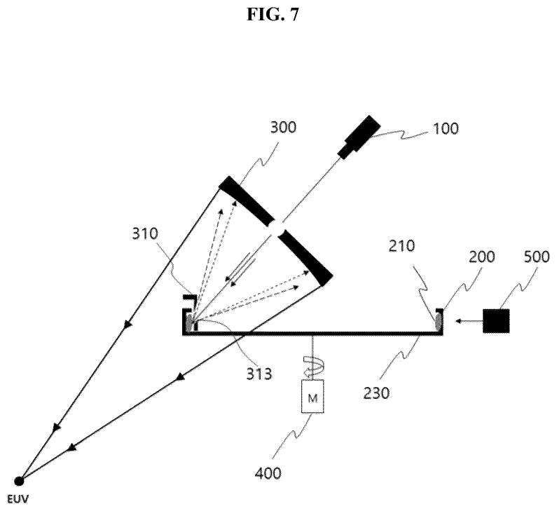

FIG. 7 is a plan view of a fragment shield of the shield-integrated rotational disk EUV light source device including a fragment shield according to the present invention. Since fragmented target material particles may be generated by the target material in the EUV light source device on the collector mirror and a plurality of optical systems or components and might interfere with the optical properties, a fragment shield 310 for blocking the fragmented particles can be arranged.

The fragment shield 301 is positioned to surround the target material placed on the rotational disk rim, thereby preventing fragment particles generated from the target material.

In this instance, the fragment shield includes a single beam hole 313 to allow the beam emitted from the laser source 100 to irradiate to the target material and allow the collector mirror 300 to receive the EUV light reflected from the target material. The single beam hole can be used as a penetration hole through which the incident beam irradiated to the target material and the reflective beam reflected from the target material pass.

If two holes are formed in the fragment shield for the incident beam and the reflective beam, there may occur a problem in arrangement of the incident beam and the reflective beam due to interference between the two holes. However, using a single beam hole solves the problem.

Accordingly, the fragment shield with the single hole is advantageous for collecting EUV light over a wide solid angle and blocking simultaneously generated fragments from the optical systems.

The present invention has been described primarily in terms of the on-axis method, but can also be configured in an off-axis manner if necessary.

That is, as occasion demands, the collector mirror for collecting EUV light may have a spherical, aspherical, or elliptical shape to collect light in an on-axis manner or in an off-axis manner.

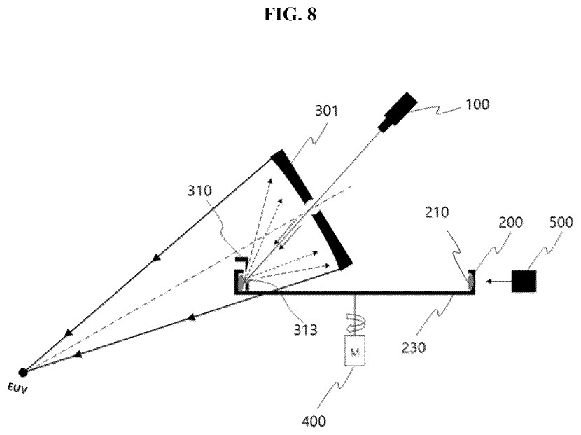

FIG. 8 is a plan view illustrating the EUV light source device with the off-axis type light collection structure to which the target material feeder with an excellent structure for generating EUV light is applied.

As illustrated in FIG. 8, the fragment shield includes a single beam hole 313 to allow the beam emitted from the laser source 100 to irradiate to the target material and allow the collector mirror 300 to receive the EUV light reflected from the target material. The single beam hole can be used as a penetration hole through which the incident beam irradiated to the target material and the reflective beam reflected from the target material pass.

The beam incident on an off-collector mirror 301 is collected to generate EUV light. At this time, an off-center axis C2 of the off-collector mirror 301 is not parallel to a center axis C1 of the laser beam emitted from the laser source and incident on the target material, thus the off-center axis C2 of the off-collector mirror 301 and the center axis C1 of the laser beam form an off-axis configuration.

Such an arrangement helps to avoid interference with peripheral equipment or the rotational disk.

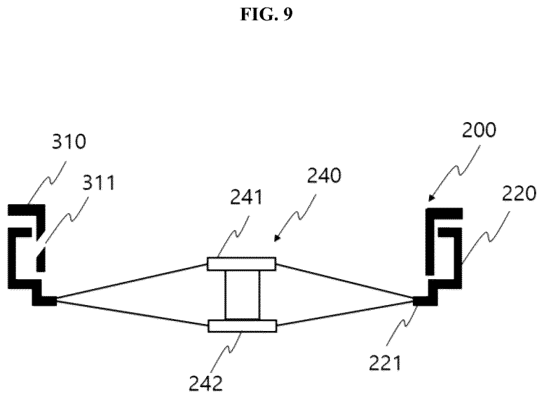

FIG. 9 is a cross-sectional view of a fragment shield in the shield-integrated rotational disk EUV light source device according to the present invention.

As illustrated, FIG. 9 is an enlarged view of the fragment shield 310. The fragment shield 310 is designed to surround around the inner surface of the rotational disk rim 220 to minimize the leakage of particles scattered from the target material when the laser beam interacts with the target material.

In this instance, a laser beam emitted from the laser source 100 reacts with the target material located on the inner wall surface of the rotational disk rim due to centrifugal force while the target rotational disk rotates, generating EUV light. A beam hole 311 is positioned to correspond to the laser beam incident direction. That is, the beam hole 311 is configured on only one side of the fragment shield 310.

Thus, the rotational disk 200 and the fragment shield 310 are independently structured. That is, the rotational disk rotates, but the fragment shield 310 remains fixed to an external structure.

Additionally, the rotational disk hub 240 includes an upper flange 241 and a lower flange 242 to have a robust coupling structure with the rotational disk rim. The upper flange 241 and the lower flange 242 are coupled by the rotational disk rim 220, and in this instance, are coupled through a rim flange 221 which extends from the rotational disk rim 220.

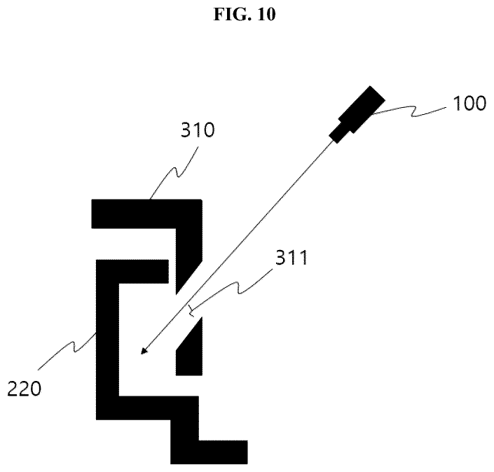

FIG. 10 is a sectional enlarged view of the fragment shield of the shield-integrated rotational disk EUV light source device according to the present invention. As illustrated, the fragment shield 310 and the rotational disk rim 220 are spaced apart at a predetermined distance to avoid interference with the fragment shield during the rotation of the rotational disk.

In addition, the fragment shield 310 has an outwardly bent shape to completely surround the inner surface of the rotational disk rim 220. For instance, the fragment shield 310 has an ‘L’ shape to surround the rotational disk rim 220 and is fixed to an external structure. Then, when the rotational disk rotates while surrounding the outside of the fragment shield, EUV light is generated by the reaction of the target material and the laser beam. In this instance, the fragment shield 310 prevents the leakage of target material fragments to the outside.

Moreover, the beam hole 311 is formed to have an angle identical to the incident angle of the laser beam emitted from the laser source, thereby minimizing interference with the incident angle of the laser beam. EUV light generated during the interaction between the laser beam and the target material passes through the beam hole 311 and is directed toward the collector mirror 300.

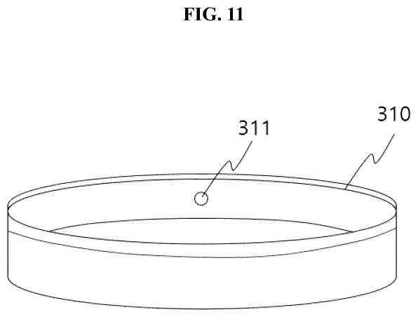

FIG. 11 is a diagram of the fragment shield of the shield-integrated rotational disk EUV light source device according to the present invention, viewed from the inside. FIG. 11 illustrates a beam hole formed in the fragment shield 310, which is formed only on one side. The fragment shield 310 has a simple structure, is easy to manufacture, and is also easy to apply to the device.

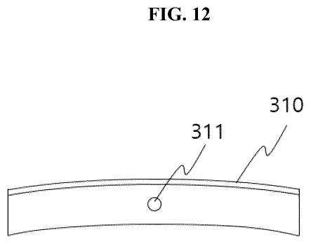

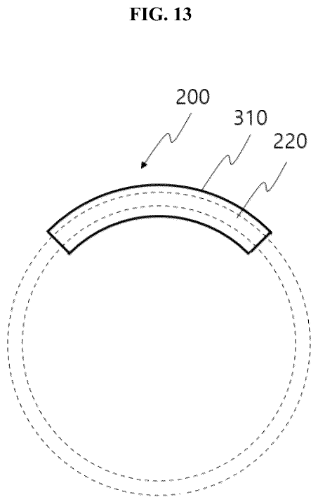

FIG. 12 is a perspective view of a fragment shield of a shield-integrated rotational disk EUV light source device including a fragment shield according to another embodiment of the present invention, and FIG. 13 is a plan view of the fragment shield according to FIG. 12.

FIGS. 10 and 11 illustrate the form that the fragment shield 310 fully surrounds the inner surface of the rotational disk.

In another embodiment, the fragment shield 310 may be formed to a predetermined length to surround only a portion of the inner surface of the rotational disk. The fragment shield does not fully surround the inner surface of the rotational disk but surrounds only the predetermined length around a region where the laser beam interaction occurs, thereby preventing fragments from scattering to the predetermined length.

While the preferred embodiments of the present invention have been described and illustrated to exemplify the principles of the present invention, the present invention is not limited to the aforementioned specific embodiments. It will be appreciated to those skilled in the art that the present invention can be changed and modified in various manners without departing from the spirit and scope of the present invention. Accordingly, all proper changes, modifications, and equivalents should be construed as belonging to the scope of the present invention.

What is claimed is:

1. An shield-integrated rotational disk EUV light source device including a fragment shield, comprising:
a rotational disk having a rotational disk rim which melts a target material for generating EUV light through plasma reactions;
a plurality of rotational disk ribs supporting the rotational disk rim so that EUV light penetrates relative to a predetermined area among a light focusing region; and
a fragment shield surrounding a plasma reaction region of the rotational disk rim to prevent the generation of target material fragments when the target material melted on the rotational disk rim causes a plasma reaction by the beam emitted from the laser source.

2. The shield-integrated rotational disk EUV light source device according to claim 1, wherein the rotational disk ribs supporting the rotational disk rim are configured to allow EUV light to penetrate relative to a predetermined area of a light focusing region through a collector mirror, which irradiates the beam emitted from a laser source to the target material by penetrating the beam to the center, receives the EUV light reflected from the target material, and collects the EUV light to the same incident light axis.

3. The shield-integrated rotational disk EUV light source device according to claim 1, wherein the fragment shield has a single beam hole through which the laser emitted from the laser source is received and the EUV light generated from the target material passes.

4. The shield-integrated rotational disk EUV light source device according to claim 3, wherein the fragment shield has a circular shape to surround the inner circumferential surface of the rotational disk rim formed on the inner surface of the rotational disk.

5. The shield-integrated rotational disk EUV light source device according to claim 3, wherein the beam hole has a predetermined diameter size to have an angle identical to the incident angle of the laser beam emitted from the laser source, and the EUV light generated by the interaction with the target material is reflected at an angle of the beam hole to be reflected to the collector mirror.

6. The shield-integrated rotational disk EUV light source device according to claim 3, wherein the fragment shield is formed to cover only a certain section with a predetermined length relative to the inner diameter of the rotational disk rim formed on the inner surface of the rotational disk.

7. The shield-integrated rotational disk EUV light source device according to claim 1, wherein the rotational disk rib includes a single rotational disk hub positioned at the center to connect the rotational disk hub to the rotational disk rim.

8. The shield-integrated rotational disk EUV light source device according to claim 7, wherein the rotational disk hub includes an upper flange and a lower flange, which are connected to the rim flange via the rotational disk rim.

9. The shield-integrated rotational disk EUV light source device according to claim 4, wherein the fragment shield has an “L” shape and is fixedly installed to cover the inner surface of the rotational disk rim.

10. The shield-integrated rotational disk EUV light source device according to claim 1, wherein when EUV light is generated by reaction between laser emitted from the laser source and the target material of the rotational disk rim according to the incident angle of the laser, the EUV light source device reflects the EUV light to the collector mirror at an angle identical to the incident angle, and then, reflects the EUV light from the collector mirror in an on-axis structure with the same incident angle.

11. The shield-integrated rotational disk EUV light source device according to claim 1, wherein when EUV light is generated by reaction between laser emitted from the laser source and the target material of the rotational disk rim according to the incident angle of the laser, the EUV light source device reflects the EUV light to the collector mirror at an angle identical to the incident angle, and then, reflects the EUV light from the collector mirror in an off-axis structure with the same incident angle.
